(19) United States
(12) Patent Application Publication
(10) Pub. No.: US 2005/0084981 A1
(43) Pub. Date: Apr. 21, 2005

(54) Method of depositing a bioactive material on a substrate

(76) Inventors: Magdalena Ostrowski, San Jose, CA (US); Dan-Hui Yang, Sunnyvale, CA (US); Catherine Keely Templin, Portola Valley, CA (US); Jeffrey Thomas Kernan, Santa Cruz, CA (US); Mark Thomas Westall, San Francisco, CA (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/688,445

(22) Filed: Oct. 16, 2003

(51) Int. Cl. G01N 1/10

(52) U.S. Cl. 436/180

(57) ABSTRACT

A method is provided of depositing a plurality of droplets of a bioactive material at a first concentration in a fluid to form a spot on a substrate, the spot having a first bioactivity level; and controlling the plurality of droplets to control the size of the spot and control the bioactivity level of the spot to not be equal to the number of droplets times the first bioactivity level.

### TECHNICAL FIELD

The present invention relates to methods for depositing materials and, more particularly, to depositing bioactive materials on a substrate.

### BACKGROUND ART

A huge number of life-saving and life-enhancing drugs are now being developed in chemical and biological research, development, and manufacturing, in fields such as combinatorial chemistry, genomics, bioinformatics, genetics, proteomics, and high-throughput (HTP) biochemistry. Genomics provides information on the genetic composition and the activity of an organism's genes. Bioinformatics uses computer algorithms to recognize and predict structural patterns in DNA and proteins, defining families of related genes and proteins. These fields often require the simultaneous handling of small quantities of many different fluids including gases and liquids. Gases can often be handled easily using tubing and manifolds, but liquid handling is often difficult.

Liquid samples are often handled and stored in microtiter plates. Microtiter plates are rectangular trays made of glass or plastic. They contain many small liquid reservoirs adjacent to one another for reacting and storing liquids in typical arrays sizes of 96 in an 8×12 array of 400 microliter (μl) wells on 9 millimeter (mm) spacing, 384 in a 16×24 array of 100 μl wells on 4.5 mm spacing, or 1536 in a 32×48 array of 10 μl wells on 2.25 mm spacing. Transferring the many liquid samples from microtiter plates to other formats such as micro arrays presents many challenges.

Drug screening of soluble targets, such as proteins and peptides, against solid-phase synthesized drug components is problematic. The surfaces required for solid state organic synthesis are chemically diverse and often cause the inactivation or non-specific binding of proteins, leading to a high rate of false-positive results and high non-specific background. Furthermore, the chemical diversity of drug compounds is limited by the combinatorial synthesis approach that is used to generate the compounds at the interface. Another major disadvantage of this approach stems from the limited accessibility of the binding site of the soluble targets, such as proteins, to the immobilized drug candidates.

The DNA micro array technology currently in use for nucleic acid hybridization assays (DNA-chips) is also not readily transferable to protein assays. Nucleic acids withstand temperatures up to 100° C., can be dried and re-hydrated without loss of activity. In contrast, proteins must be kept at ambient temperatures, and are very sensitive to the physical and chemical properties of the support materials. Additionally, the proper orientation of the protein at the interface is desirable to ensure accessibility of their active sites with interacting molecules.

In addition to achieving high-throughput detection of targets to identify potential drug leads, researchers also need to be able to identify a highly specific lead compound early in the drug discovery process. Analyzing the many members of a protein family or forms of a polymorphic protein in parallel enables quick identification of highly specific lead compounds. Proteins within a structural family share similar binding sites and catalytic mechanisms. Often, a compound that effectively interferes with the activity of one family member also interferes with other members of the same family. Using standard technology to discover such additional interactions requires a tremendous effort in time and costs and as a consequence is simply not done.

High-throughput screening is highly desirable because cross-reactivity of a drug with related proteins can be the cause of low efficacy or even side effects in patients. For instance, AZT, a major treatment for AIDS, blocks not only viral polymerases, but also human polymerases, causing deleterious side effects. Cross-reactivity with closely related proteins is also a problem with nonsteroidal anti-inflammatory drugs (NSAIDs) and aspirin. These drugs inhibit cyclooxygenase-2, an enzyme that promotes pain and inflammation. Unfortunately, the same drugs also strongly inhibit a related enzyme, cyclooxygenase-1, that is responsible for keeping the stomach lining and kidneys healthy, leading to common side-effects including stomach irritation.

In DNA Micro array technology, a protein array is currently under development, which provides a high-throughput methodology to study protein-protein interaction, protein expression, protein-small molecule interactions and kinases activity towards families of specific peptide sequences and protein targets. As a result of the need for high-throughput screening, micro arrays of binding agents have become an increasingly important tool in the biotechnology industry and related fields. Such arrays, in which such binding agents as oligonucleotides, peptides, or proteins are deposited onto a solid support surface in the form of an array or pattern, and can be useful in a variety of applications, including gene expression analysis, protein expression analysis, protein target detection, drug screening, nucleic acid sequencing, mutation analysis, and the like.

Such arrays may be prepared in any of a variety of different ways, many of which rely on transferring liquids from an array of liquid samples in one or more microtiter plates to the substrate on which the micro array is formed. For example, DNA arrays may be prepared by: manually spotting DNA onto the surface of a substrate with a micropipette; a dot-blot approach or a slot-blot approach in which a vacuum manifold transfers aqueous DNA samples from a plurality of reservoirs to a substrate surface; dipping an array of pins into an array of fluid samples and then contacted with the substrate surface to produce the array of sample materials; using an array of capillaries to produce biopolymeric arrays; or constructing arrays of biopolymeric agents in discrete regions on the surface of the substrate.

There is a continued interest in developing methods and devices for making arrays of biomolecules, in which the apparatus is less complicated and more automated and the methods reduce waste of biological material that may be in limited supply, and which result in efficient and reproducible rapid production of more versatile and reliable arrays.

For the foregoing reasons, there is a need for miniaturized protein arrays and for methods for the parallel, in vitro, high-throughput screening of functionally and/or structurally related protein targets against potential drug compounds in a manner that minimizes reagent volumes and protein inactivation problems.

Another problem associated with depositing biomolecules is that the concentration of the biomolecules is limited by commercial availability as well as printing instrumentation. Thus, printing once (also referred as single ejection of the bioactive molecules) provides a limited number of molecules on a substrate. Importantly, this will lead to a decrease in sensitivity for target detection.

Solutions to these problems have been long sought but prior developments have not taught or suggested any solutions and, thus, solutions to these problems have long eluded those skilled in the art.

### DISCLOSURE OF THE INVENTION

The present invention provides a method of depositing a plurality of droplets of a bioactive material at a first concentration in a fluid to form a spot on a substrate, the spot having a first bioactivity level; and controlling the plurality of droplets to control the size of the spot and control the bioactivity level of the spot to not be equal to the number of droplets times the first bioactivity level. This method increases effective concentration of the first spot while decreasing sample consumption of a depositing device. The aggregation of proteins on the substrate in many cases helps retain their bioactivity.

The above and additional advantages of the present invention will become apparent to those skilled in the art from a reading of the following detailed description when taken in conjunction with the accompanying drawings.

### BRIEF DESCRIPTION OF THE DRAWINGS

FIG. 1 is a cross-sectional view of a portion of a fluid handling system of an embodiment of the present invention;

FIG. 2 is a data chart showing the results of the present invention; and

FIG. 3 is the method of depositing a bioactive material in accordance with the present invention.

### BEST MODE FOR CARRYING OUT THE INVENTION

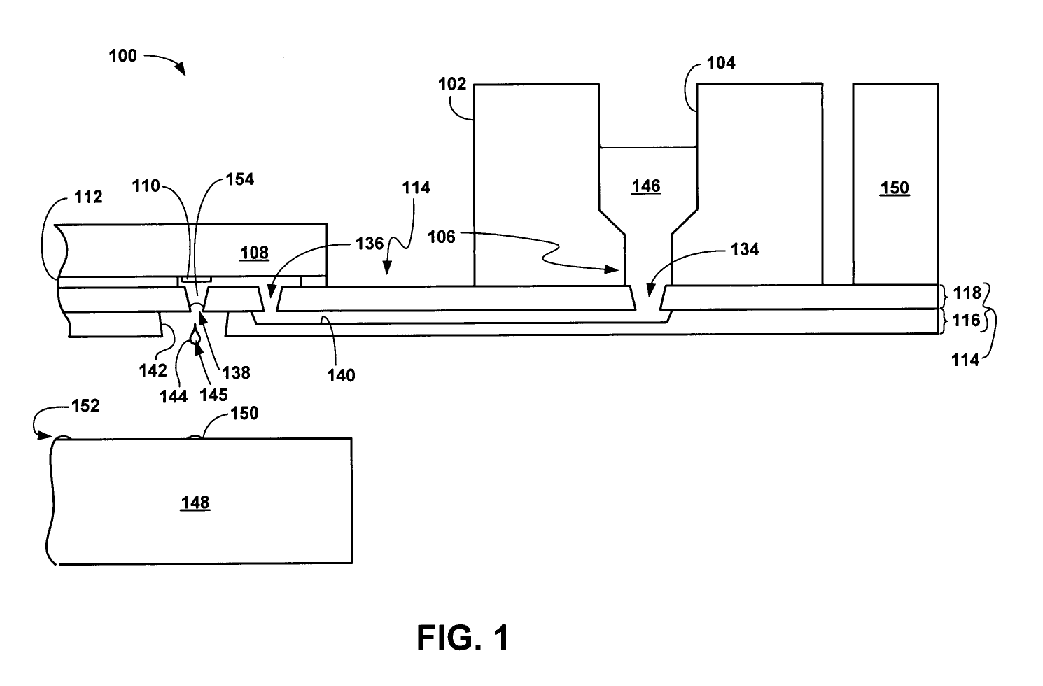

FIG. 1 shows a cross-sectional view of a portion of a fluid handling system 100 based on an ink jet printing system. The fluid handling system 100 includes a microtiter manifold (MTM) 102 made of a rigid material, such as stainless steel. The MTM 102 has a reservoir 104 provided therein. The reservoir 104, typically having a fluid volume of 1 to 3 microliters (μL), is optionally provided with a neck portion 106 at the downstream end.

The fluid handling system 100 further includes a deposition chip 108, which carries ejection means 110 and a barrier 112.

A format compression manifold (FCM) 114 is bonded to the MTM 102 and the barrier 112. The FCM 114 consists of a first sheet 116 bonded to a second sheet 118. The first and second sheets 116 and 118, respectively, could be high strength metal foils bonded by adhesive or single sheets of self-adhesive polymers.

The second sheet 118 has various openings, including fluid access holes 134 and 136 and an orifice 138, provided therein. The fluid access holes 134 and 136, and the orifice 138 are generally laser ablated into the second sheet 118. In a similar manner, a capillary 140 is formed into the first sheet 116 so as to connect the fluid access holes 134 and 136 when the first and second sheets 116 and 118 are properly aligned. A droplet-pass-through hole 142 is also formed into the first sheet 116.

In operation, a droplet 144 of a uniform volume of bioactive material 145 is ejected from the fluid handling system 100 through the droplet-pass-through hole 142 after being ejected from the orifice 138 by ejection means 110. The droplet 144 has a substantially uniform volume of between 5-20, 21-50, 51-100, or 100-200 picoliters (pl) depending on the fluid handling system 100 and contains various bioactive materials and liquids. The ejection means 110 is typically an electrically heated resistor, which acts by explosive boiling of a fluid 146 to eject the droplet 144, although other ejection means such as piezoelectric means may also be used.

After ejection, the droplet 144 is deposited on a substrate 148, such as a chemically modified glass slide. The chemically modified glass slide may be chemically modified in a number of different ways, such as by the addition of a hydrophobic or hydrophilic surface layer, or a coating of polylysine, for example.

After deposition, the droplet 144 forms a bioactive spot 150, which is one sample point in a high-density biomolecule spot micro array. A number of bioactive spots, or spots 150, are printed to form a high-density biomolecule spot micro array 152. The high-density biomolecule spot micro array 152 is considered “high-density” because the spots 150 can be very closely packed together with spacing determined by single droplet spots.

The fluid 146 occupies a continuous fluid path extending from the reservoir 104, through the fluid access hole 134, through the capillary 140, and through the fluid access hole 136 to an ejection chamber 154. The ejection chamber 154 is walled by the deposition chip 108 on its upper surface, by the barrier 112 on its sides, and by the second sheet 118 on its bottom surface.

The first and second sheets 116 and 118 together form the walls of the capillary 140 and are adhesively bonded together to create the FCM 114 containing hundreds of capillaries which are similar to the capillary 140, hundreds of droplet pass-through holes such as the droplet-pass-through hole 142, hundreds of orifices such as the orifice 138, and hundreds of fluid access holes such as the fluid access holes 134 and 136. The MTM 102 is secured to the FCM 114 and contains hundreds of fluid reservoirs such as the reservoir 104, each of which is in fluid communication with a capillary on the FCM 114 such as the capillary 140.

The fluid handling system 100 provides a method of depositing biological material onto the substrate 148.

In the past, it has been believed that it was desirable to deposit a high concentration of biomolecules on a substrate to provide highly biologically active spots by using high concentration samples to increase the quantity of biomolecules in the carrying fluid and thus in each individual droplet.

Unfortunately, there have been many disadvantages to using a high concentration sample above 500 micrograms/milliliter (μg/mL) to form a high concentration spot with such fluid handling systems.

One disadvantage was the volume of material required in the fluid handing system to load, fill, and prime the reservoir. Typically, the reservoir must be filled to its fluid volume. Then, one droplet was ejected, which was just a fraction of the reservoir volume. For a single array, only a single droplet or single ejection was performed from a reservoir per array so the remaining 99+% of the bioactive material in the reservoir, the capillary, the ejection chamber, fluid access holes, and the orifice was wasted.

Another disadvantage was that high concentrations of biological materials tended to clump and clog the orifice since the orifice is extremely small. Related to this is the requirement for additives in the fluid that control parameters of the fluid such as surface tension and stability (to improve printing performance, to keep the biological materials suspended in the fluid or to keep them from deteriorating), which result in the sample concentration being diluted in any event.

In some cases, a particular printing buffer with specific fluid properties must be used to match the fluid characteristics of the print head. In this case, the samples must be either buffer exchanged through an exchange column or through dialysis. Both of these processes are inadequate because they result in the loss of some of the biopolymer sample through the transfer steps. When an imperfectly matched printing buffer is used, undesirable formation of irregular spots and satellites to the spots may occur. This detrimentally affects testing accuracy because the test apparatus is calibrated with uniform spots with no unexpected satellites.

A further disadvantage is that most biological materials are very expensive. For example, proteins are the major components of cells. They determine the shape, structure, and function of the cell. Proteins are assembled by 20 different amino acids each with a distinct chemical property. This variety allows for enormous versatility in the chemical and biological properties of different proteins. Biomolecules are sold or stocked in “standard concentrations”, which are changed by suppliers from time to time but which are well known to those having ordinary skill in the art.

For example, some proteins are currently sold or stocked in standard concentrations of about 500 μg/mL and the cost for the standard concentration of protein ranges from a couple of hundred to a couple of thousand US dollars per milligram (mg). Other biological materials, which can be used in accordance with the present invention can be much more expensive. For example, the cytokine family of proteins may cost between a couple of hundred to a couple of thousand per microgram (μg). However, new proteins are being discovered at an unprecedented rate and protein structure, function and interaction studies are lagging behind so the cost has been accepted as required for doing business because of the importance of this area.

Antibodies and recombinant proteins are powerful tools for protein studies. Antibodies are a large family of glycoproteins that specifically bind antigens. A protein can be identified by its specific antibodies in immunochemical methods such as Western blot, immunoprecipitation, and enzyme linked immunoassay. Monoclonal and polyclonal antibodies against most known proteins have been generated and widely used in both research and therapy. Genes can be readily expressed in organisms like bacteria and yeast and this has made recombinant proteins convenient and indispensable tools in protein structure and function studies. There is a growing demand for recombinant proteins, especially in large scale screening of drug targets and in clinical medicine.

Today, numerous antibodies and recombinant proteins have been produced. By using a large number of antibodies or recombinant proteins in a single experiment, a protein array on the substrate 148 can be used to analyze proteins in large scale and high-throughput fashion.

To accomplish this analysis it is necessary to immobilize proteins on the substrate 148 during the process of studying the proteins. The attachment of the protein on solid support can be covalent and non-covalent. Non-covalent interactions include electrostatic interaction and molecular interaction. Molecular interaction should include hydrophobic-hydrophobic interaction, hydrophilic-hydrophilic interaction and hydrogen bonding etc. If the protein is deposited on a non-charged hydrophobic surface, the interaction is mostly hydrophobic-hydrophobic interaction. If the surface is a charged hydrophobic surface, the interaction is then a combination of electrostatic and hydrophobic-hydrophobic interactions.

In Western blot analysis, proteins of interest are first separated by electrophoresis and then transferred and immobilized onto a nitrocellulose or a polyvinylidene difluoride (PVDF) membrane. In the phage display screening of a protein expression library, several hundred thousand proteins expressed by phages are immobilized on membranes. In both Western blotting and phage display screening, proteins are immobilized non-covalently.

Once immobilized, the protein of interest is then selected by a unique property such as its interaction with an antibody, or other types of targets. In some other applications such as immunoprecipitation and affinity purification, agents (e.g., antibodies, ligands) are covalently conjugated onto solid supports (e.g., agarose beads) through their primary amines, sulfhydryls or other reactive groups. In general, proteins retain their abilities to interact with other proteins or ligands after immobilization.

Monitoring the expressions and properties of a large number of proteins is desired in many important applications. One such application is to reveal protein expression profiles. A cell can express a large number of different proteins. And the expression patterns (the number of proteins expressed and the expression levels) vary in different cell types. This difference is the primary reason that different cells have different functions. Since many diseases are caused by the change in protein expression pattern, comparing protein expression patterns between normal and disease conditions may reveal proteins whose changes are critical in causing the disease and thus identify appropriate therapeutic targets. Methods of detecting protein expression profiles will also have other important applications including tissue typing, forensic identification, and clinical diagnosis. Protein expression pattern can be examined with antibodies in an immunoassay, but usually in a small scale.

Protein posttranslational modifications (e.g., phosphorylation, glycosylation, and ubiquitination) play critical roles in regulating protein activity. One of the modifications is phosphorylation at either serine, threonine or tyrosine residues. Protein phosphorylation is an important mechanism in signal transduction. Aberrant protein phosphorylation contributes to many human diseases.

Among the methods of detecting protein phosphorylation, metabolic labeling of cells with radioisotopes and immuno-detection of phosphoproteins with antibodies are the most commonly used. However, these methods are only applicable to analyzing one or several proteins each time. Antibodies specific for phosphorylated amino acids, such as PY20, can reveal multiple phosphorylated proteins, but fail to identify them.

Protein-protein interaction is an important way by which a protein carries out its functions. Currently, there are several methods to detect protein—protein interactions. Among them, co-immunoprecipitation, yeast two-hybrid screening, and phage display library screening are the most commonly used. Label detection techniques such as fluorescent molecules attached to the proteins have also been used.

The fluid handling system 100 is capable of depositing bioactive materials 145, such as proteins, peptides, reagents, enzymes, genes, DNA, and a combination thereof at different concentrations from the standard concentrations.

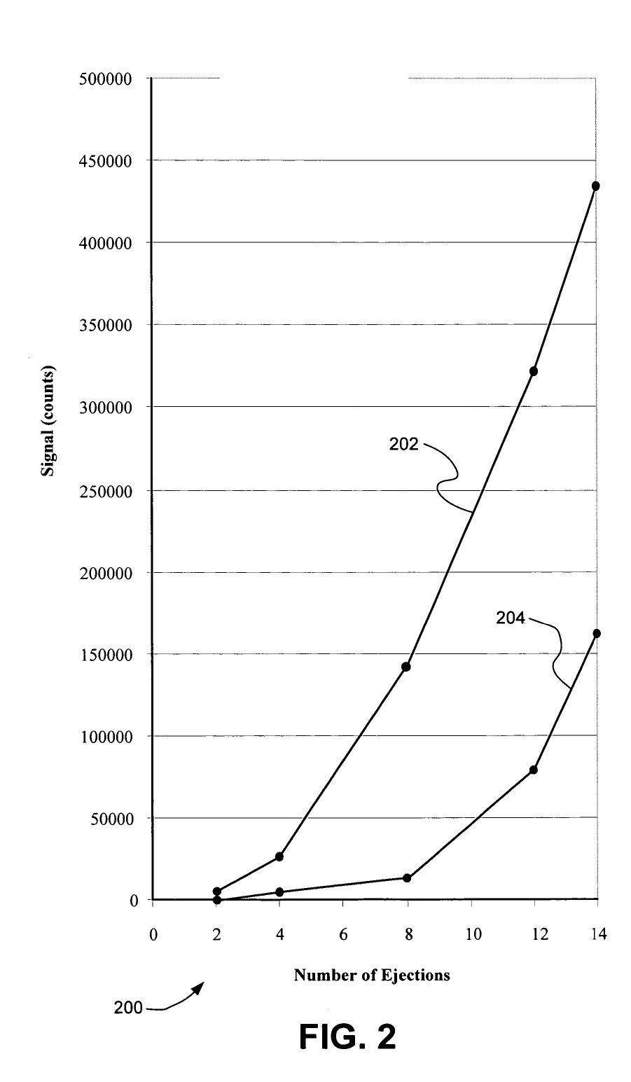

Referring now to FIG. 2, therein is shown a data chart 200 illustrating the present invention.

A standard concentration of anti-IgG1 solution of 500 μg/mL was diluted down to 200 μg/mL and 100 μg/mL in an appropriate printing buffer solution for test purposes and multiple fires were used to increase the “effective concentration” on the substrate 148.

The fluid handling system 100 was used for deposition in which sets of ejections of two droplets per set were deposited. The timing between the droplets within a set of droplets was determined empirically so the droplets did not dry on the substrate 148 between sets. The timing between the sets was determined empirically so the droplets did dry on the substrate 148 between sets. The time between the sets was between five and forty-five seconds.

The binding included washing the high-density biomolecule spot micro array 152 with casein block (Pierce, catalog # 37528) (a milk protein) in phosphate buffered saline (PBS) for about ten minutes. A rinse in PBS was followed by a wash in PBS for about ten minutes.

The high-density biomolecule spot micro array 152 was then exposed to a target of Bt-IgG at a concentration of 1 μg/mL in casein block and the target and spots were allowed to bind for one hour.

After binding, the high-density biomolecule spot micro array 152 was rinsed with PBS-0.05% Tween-20 and washed twice with PBS-0.05% Tween-20 for ten minutes each. This was followed by a PBS rinse and a PBS wash for five minutes. Drying followed a rinse with deionized water.

An antibody binding micro array assay was performed, which indicates bioactivity level by detecting fluorescent molecules bonded to biomolecules, such as the anti-IgG1. With the antibody binding micro array assay, the greater the number of bonded biomolecules, the greater will be the signal in “counts” and the greater will be the bioactivity level of a spot. Increasing the bioactivity level of the spot makes the test more sensitive.

Those having ordinary skill in the art have expected that, if a first droplet of a bioactive material at a certain concentration were deposited to form a spot of a certain size and tested to have a first bioactivity level, a second droplet of the bioactive material at the certain concentration in the fluid deposited to maintain the spot at substantially the certain size and tested would have twice the first bioactivity level, a third droplet of the bioactive material at the certain concentration in the fluid deposited to maintain the spot at substantially the certain size and tested would have three times the first bioactivity level, etc.; i.e., the bioactivity level increases should be substantially linearly proportional to the number of droplets because the effective concentration of the deposited bioactive material would increase linearly with the number of droplets.

The initial data chart, similar to FIG. 2, did not show a linear increase in bioactivity proportional to the number of droplets or increase in effective concentration as was expected.

Due to the unexpected nature of the initial test results, additional tests were run to confirm the accuracy of the test results.

The data chart 200 shows 200 μg/mL test results as a plot 202 and 100 μg/mL test results as a plot 204. In the data chart 200, each data point on the data chart 200 is an average of 250 replicated readings taken over four arrays.

For the 200 μg/mL tests, it was discovered the spot 150 resulting from two droplets 144 has a bioactivity level of about 22,000 counts and from four droplets 144 has a bioactivity level about 25,000 counts; i.e. less than a linear increase. The spot 150 resulting from four droplets 144 has a bioactivity level about 22,000 counts and from eight droplets 144 has a bioactivity level about 142,000 counts; i.e. more than a linear increase. This continues to increase non-linearly past 430,000 counts at fourteen droplets 144. The transition from a less than linear increase to a more than linear increase indicates that (a portion between some droplets at certain concentrations may also be substantially linear for those portions).

For the 100 μg/mL tests, it was discovered the spot 150 resulting from two droplets 144 has a bioactivity level about 500 counts and from four droplets 144 has a bioactivity level 2,700 counts; i.e. more than a linear increase. The spot 150 resulting from eight droplets 144 has a bioactivity level about 12,500 counts and from twelve droplets 144 has a bioactivity level about 80,600 counts; i.e. much more than a linear increase. This also continues to increase by substantial numbers and non-linearly past 162,500 at fourteen droplets 144.

The actual averaged data points are:

| drops | 100 ug/mL | 200 ug/mL |
|---|---|---|
| 2 | 500 | 22,000 |
| 4 | 2,700 | 25,000 |
| 8 | 12,500 | 142,800 |
| 12 | 80,600 | 320,700 |
| 14 | 162,500 | 434,800 |

Thus, contrary to expectations, the bioactivity level increases are not linearly proportional to the number of droplets or the amount of bioactive material deposited.

Also, contrary to expectations, four droplets at half concentration provide a non-proportional bioactivity level of the biomolecules than two droplets at full concentration even though the number of biomolecules and the bioactivity level would be expected to be the same.

The above meant that the high-density biomolecule spot micro array 152 can be formed using a lower than standard concentration by shooting multiple ejections.

While the exact reasons for the unexpected results are no known, it is postulated that protein aggregation caused by multiple ejections of droplets helps retain antibody activity to levels that are not linearly proportional to the number of ejections. The first drops may be denatured on the surface and the successive layers have a high proportion of active biomolecules. “Denatured” means a protein may lose its bioactivity due to its structure collapse or its binding site (a short sequence of amino acids) deactivated by the interaction with surface.

Based on the above test data, it has been unexpectedly found that, if a first droplet of a bioactive material at a certain concentration is deposited to form a spot of a certain size and tested to have a first bioactivity level, a second droplet of the bioactive material at the certain concentration in the fluid deposited to maintain the spot at substantially the certain size and tested would not have twice the first bioactivity level, a third droplet of the bioactive material at the certain concentration in the fluid deposited to maintain the spot at substantially the certain size and tested would have would also not have three times the first bioactivity level, etc. The bioactivity level changes are not substantially linearly proportional to the number of droplets or effective concentration. Above four droplets, the bioactivity level is at least a multiple of the number of droplets.

Further, it has been unexpectedly found that the bioactivity level changes will not be a linear increase or decrease as compared to the expected linear increase, and sometimes will have a linear change for a portion of the bioactivity level change over a number of droplets depending upon the size of the bioactive molecules, their interaction with the substrate upon which they are deposited, and the interaction of the bioactive molecules among themselves.

Still further, it has been unexpectedly found that the bioactivity level changes will substantially increase above a linear increase with multiple droplets without drying between depositions, with multiple droplets in sets of droplets with drying between the sets of depositions, and with various combinations of droplets and drying/not drying.

Even further, it has been unexpectedly found that multiple droplets can be deposited on a spot while maintaining the spot at least at substantially the size of the first spot with controlled drying/not drying will have even greater bioactivity level changes. The “at least at substantially” the size of the first spot is defined with the first spot being generally round and having a rough diameter, which does not increase more than about 10% in diameter with subsequent droplets deposited. This permits the process to form high-density biomolecule spot micro arrays of previously unattainable high sensitivity.

Further experimentation determined signal changes from the antibody binding micro array assay are due to the combination of the change in number of biomolecules deposited on the substrate and retention of their bioactivity. The resulting change in bioactivity level signal depends on the bioactive materials' size, their interaction with surface, and their interaction among themselves.

It has been also discovered that spot size and sensitivity of the test spot can be tuned. By depositing a number of droplets before the first dries completely, the size of the spot can be increased. By depositing a number of droplets with each droplet drying before the next droplet is deposited, the spot size can be maintained but the sensitivity of the test can be increased. The combination of a number of droplets in a set of droplets that are allowed to merge and grow the spot plus drying between the sets of droplets to increase sensitivity permit complete tuning. This has a major advantage of consuming less total amount of bioactive material while achieving signal sensitivity surprisingly higher than having spots formed with just a single standard concentration droplet.

It was also discovered through testing that the bioactivity level could be maximized by having a number of successive droplets dry or partially dry between droplets on the same spot 150. The drying time is a function of the makeup of the fluid, such as the buffer used, and the volume of the droplet and can range from fractions of a second to many minutes. This drying also prevents the spot 150 from substantially increasing in size while obtaining the nonlinear increase in bioactivity level, better enabling high-density micro arrays.

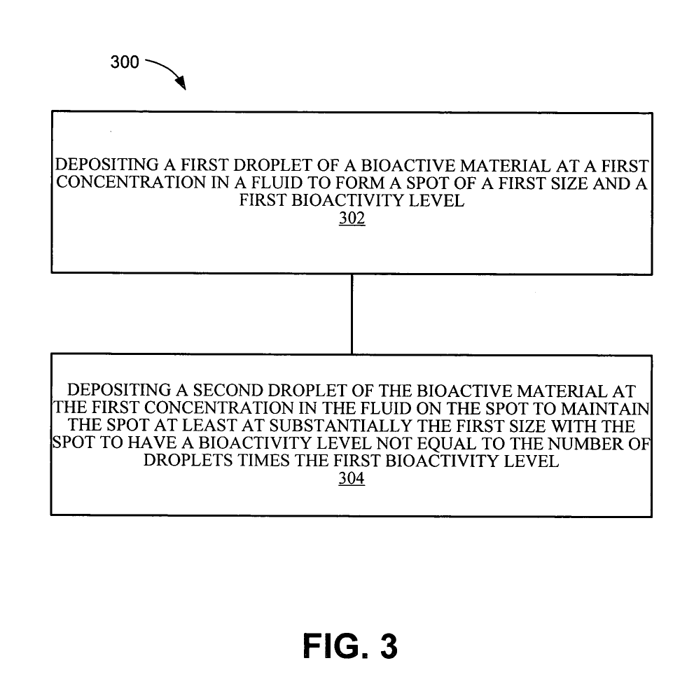

Referring now to FIG. 3, therein is shown a method 300 of depositing a bioactive material on a substrate. The method 300 includes: a step 302 of depositing a plurality of droplets of a bioactive material at a first concentration in a fluid to form a spot on the substrate, the spot having a first bioactivity level; and a step 304 of controlling the plurality of droplets to control the size of the spot and control the bioactivity level of the spot to not be equal to the number of droplets times the first bioactivity level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations which fall within the scope of the included claims. All matters hither-to-fore set forth or shown in the accompanying drawings are to be interpreted in an illustrative and non-limiting sense.

1. A method of depositing a bioactive material on a substrate comprising:
depositing a plurality of droplets of a bioactive material at a first concentration in a fluid to form a spot on the substrate, the spot having a first bioactivity level; and
controlling the plurality of droplets to control the size of the spot and control the bioactivity level of the spot to not be equal to the number of droplets times the first bioactivity level.

2. The method as claimed in claim 1 additionally comprising:
preventing the plurality of droplets from drying between droplets; and
controlling the plurality of droplets to change the size of the spot and to control the bioactivity level of the spot.

3. The method as claimed in claim 1 additionally comprising:
allowing the plurality of droplets to dry on the substrate between the droplets; and
controlling the plurality of droplets to control the spot at least at substantially the first size and to change the bioactivity level of the spot.

4. The method as claimed in claim 1 additionally comprising:
the depositing of the plurality of droplets with at least two droplets being in a set of droplets and subsequent droplets in sets of at least two droplets;
allowing the droplets in the sets of droplets to remain wet on the substrate; and
allowing the droplets to dry on the substrate in between sets of droplets.

5. The method as claimed in claim 1 additionally comprising:
providing a first multiplicity of droplets of the bioactive material at the first concentration in the fluid simultaneously on the substrate to form a multiplicity of spots having sizes substantially equal to the first size; and
providing a second multiplicity of droplets of the bioactive material at the first concentration in a fluid simultaneously on the multiplicity of spots while maintaining the multiplicity of spots at least at substantially the first size to form a high-density biomaterial spot micro array.

6. The method as claimed in claim 1 wherein:
the depositing of the plurality of droplets maintains the spot at least at substantially the size of the spot of a first droplet and has the bioactivity levels at least one of increasing non-linearly, decreasing non-linearly, linear for only a portion of the plurality of droplets, and a combination thereof.

7. The method as claimed in claim 1 wherein:
the depositing of the plurality of droplets increases the bioactivity level of the spot to more than the number of droplets times the first bioactivity level.

8. The method as claimed in claim 1 additionally comprising:
providing the bioactive material in the fluid in a standard concentration; and
processing the bioactive material in the fluid with a buffer to modify the standard concentration to provide the first concentration in the fluid.

9. The method as claimed in claim 1 wherein:
the depositing of the plurality of droplets deposits at least one of a protein, a peptide, a reagent, an enzyme, a gene, a DNA, and a combination thereof.

10. The method as claimed in claim 1 wherein:
the depositing of the plurality of droplets is performed by ejecting the droplets from a liquid handling system.

11. A method of depositing a bioactive material on a substrate comprising:
depositing a plurality of droplets of substantially equal volume of a bioactive material at a first concentration in a fluid to form a spot on the substrate, the spot having a first bioactivity level; and
controlling the plurality of droplets to control the size of the spot and control the bioactivity levels of the spot to be at least one of increasing non-linearly, decreasing non-linearly, linear for only a portion of the plurality of droplets, and a combination thereof.

12. The method as claimed in claim 11 additionally comprising:
preventing the plurality of droplets from drying between droplets; and
controlling the plurality of droplets to increase the size of the spot and to increase the bioactivity level of the spot.

13. The method as claimed in claim 11 additionally comprising:
allowing the plurality of droplets to dry on the substrate between the droplets; and
controlling the plurality of droplets to maintain the size of the spot at least at substantially the first size and to increase the bioactivity level of the spot.

14. The method as claimed in claim 11 wherein:
the depositing of the plurality of droplets with a number of droplets being in a set of droplets and subsequent droplets in sets of the same number of droplets;
allowing the droplets in the sets of droplets to remain wet on the substrate; and
allowing the droplets to dry on the substrate in between sets of droplets.

15. The method as claimed in claim 11 additionally comprising:
providing a first multiplicity of droplets of the bioactive material at the first concentration in the fluid simultaneously on the substrate to form a multiplicity of spots having sizes substantially equal to the first size;
providing a second multiplicity of droplets of the bioactive material at the first concentration in a fluid simultaneously on the multiplicity of spots while maintaining the multiplicity of spots at least at substantially the first size to form a high-density biomaterial spot micro array; and
using the high-density biomaterial spot micro array to perform a biological test.

16. The method as claimed in claim 11 wherein:
the depositing of the plurality of droplets maintains the spot at least at substantially the size of the spot of a first droplet and has the bioactivity levels at least one of increasing non-linearly above the number of droplets times the first bioactivity level.

17. The method as claimed in claim 11 additionally comprising:
the depositing of the plurality of droplets increases the bioactivity level of the spot to a multiple of the number of droplets times the first bioactivity level; and
using the spot on the substrate to perform a biological test.

18. The method as claimed in claim 11 additionally comprising:
providing the bioactive material in the fluid in a standard concentration; and
processing the bioactive material in the fluid with a printer buffer to dilute the standard concentration to provide the first concentration in the fluid.

19. The method as claimed in claim 11 wherein:
depositing the bioactive material deposits at least one of a protein, a peptide, a reagent, an enzyme, a gene, a DNA, and a combination thereof; and
using the bioactive material on the substrate to perform a biological test.

20. The method as claimed in claim 11 wherein:
depositing the plurality of droplets is performed by ejecting the droplets from an ink jet printing system.
